(19) United States
(12) Patent Application Publication
(10) Pub. No.: US 2017/0239718 A1
(43) Pub. Date: Aug. 24, 2017

(54) METHOD OF CHANGING COVER GAS USED DURING ADDITIVE MANUFACTURING

(71) Applicant: HONEYWELL FEDERAL MANUFACTURING & TECHNOLOGIES LLC, KANSAS CITY, MO (US)

(72) Inventors: ROBERT GEORGE STEINHOFF, JR., KANSAS CITY, MO (US); KEVIN EUGENE BAUGHN, LEES SUMMIT, MO (US); BENJAMIN ROSS BROWN, LEES SUMMIT, MO (US); WESLEY ALEXANDER EVERHART, OVERLAND PARK, KS (US); JAMES MICHAEL REILLY, LEES SUMMIT, MO (US)

(73) Assignee: HONEYWELL FEDERAL MANUFACTURING & TECHNOLOGIES LLC, KANSAS CITY, MO (US)

(21) Appl. No.: 15/050,628

(22) Filed: Feb. 23, 2016

(51) Int. Cl. B22F 3/10; B33Y 30/00; B33Y 50/02; B29C 67/00; B23K 26/144; B22F 3/105; B23K 26/342; B23K 26/12; B23K 26/70; B33Y 10/00; B28B 1/00

(52) U.S. Cl. CPC B22F 3/101; B33Y 10/00; B33Y 30/00; B33Y 50/02; B29C 67/0077; B28B 1/001; B22F 3/1055; B23K 26/342; B23K 26/123; B23K 26/702; B23K 26/144; B22F 2003/1057; B22F 2998/10

(57) ABSTRACT

An apparatus and method for additive manufacturing a metal part having portions with varying microstructures. The method may include depositing an additive manufacturing powder on a surface and melting or sintering a first portion of the additive manufacturing powder while it is covered with a first type of cover gas. Next, the method may include melting or sintering a second portion of the additive manufacturing powder while it is covered with to second type of cover gas. The first portion may be a first layer of the additive manufacturing powder and the second portion may be a second layer of the additive manufacturing powder deposited after melting or sintering of the first layer. Additionally or alternatively, the first portion and the second portion may both include distinct portions of a single layer of the additive manufacturing powder.

### BACKGROUND

Additive manufacturing is a method of creating parts that uses directed energy to melt or sinter powder that is deposited on a platform and exposed uniformly to a cover gas. A first layer of powder is uniformly deposited on the build platform, and then the directed energy melts the powder to create a first layer of the part. Then another layer of powder is uniformly deposited onto the first layer, and the directed energy fuses this layer to the first layer. This process is repeated until a three-dimensional part is complete.

When building metal parts with laser-based additive manufacturing processes such as selective laser melting (SLM) or blown powder deposition, the part's microstructure can be controlled by modifying parameters such as laser speed or laser power or by modifying a starting chemistry of the powder material. In some applications, unique characteristics such as higher strength or ductility in certain areas of the part may be desired, requiring the creation of a gradient microstructure throughout the part. This gradient microstructure is difficult to achieve by laser modifications or changes in powder composition alone.

### SUMMARY

Embodiments of the present invention solve the above-mentioned problems and provide a distinct advance in the art of additive manufacturing of a part with various diverse microstructures or physical properties therethrough.

In one embodiment of the invention, a method of additive manufacturing may include the steps of depositing an additive manufacturing powder onto a surface and delivering a first type of cover gas to the surface, thus covering the additive manufacturing powder with the first type of cover gas. Next, the method may include a step of melting or sintering a first portion of the additive manufacturing powder on the surface while the first portion is exposed to the first type of cover gas. Next, the method may include the steps of delivering a second type of cover gas to the surface and melting or sintering a second portion of the additive manufacturing powder while the second portion is exposed to the second type of cover gas.

In some embodiments of the invention, a method of additive manufacturing may include the steps of depositing a first layer of an additive manufacturing powder onto a build platform of an additive manufacturing apparatus, delivering a first type of cover gas over the first layer of additive manufacturing powder, and melting or sintering the first layer of additive manufacturing powder using a directed energy source while the first type of cover gas covers the first layer of additive manufacturing powder. Next, the method may include the steps of depositing a second layer of the additive manufacturing powder onto the first layer of additive manufacturing powder deposited onto the build platform, delivering a second type of cover gas over the second layer of additive manufacturing powder, and melting or sintering the second layer of additive manufacturing powder while the second type of cover gas covers the second layer of additive manufacturing powder.

In yet another embodiment of the invention, an additive manufacturing apparatus for using multiple types of cover gas during additive manufacturing of a metal part may include a build platform, a powder deposition device for depositing an additive manufacturing powder onto the build platform, and a directed energy source for melting or sintering the additive manufacturing powder on the build platform. Furthermore, the apparatus may include a gas regulator for outputting at least two different types of cover gas over the additive manufacturing powder on the build platform, and a controller communicably coupled to the build platform, the directed energy source, the powder deposition device, and the gas regulator. The controller may comprise various circuitry and/or processors for performing the following steps: commanding the powder deposition device to deposit the additive manufacturing powder onto the build platform, commanding the gas regulator to deliver a first type of cover gas to the build platform, commanding the directed energy source to melt or sinter a first portion of the additive manufacturing powder while covered with the first type of cover gas, commanding the gas regulator to deliver a second type of cover gas to the build platform, and commanding the directed energy source to melt or sinter a second portion of the additive manufacturing powder while covered with the second type of cover gas.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the preferred embodiments and the accompanying drawing figures.

### DESCRIPTION OF THE DRAWINGS

Embodiments of the present invention are described in detail below with reference to the attached drawing figures, wherein:

FIG. 1 is a schematic view of an additive manufacturing apparatus constructed in accordance with embodiments of the present invention; and

FIG. 2 is a flowchart of a method of additive manufacturing in accordance with an embodiment of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein.

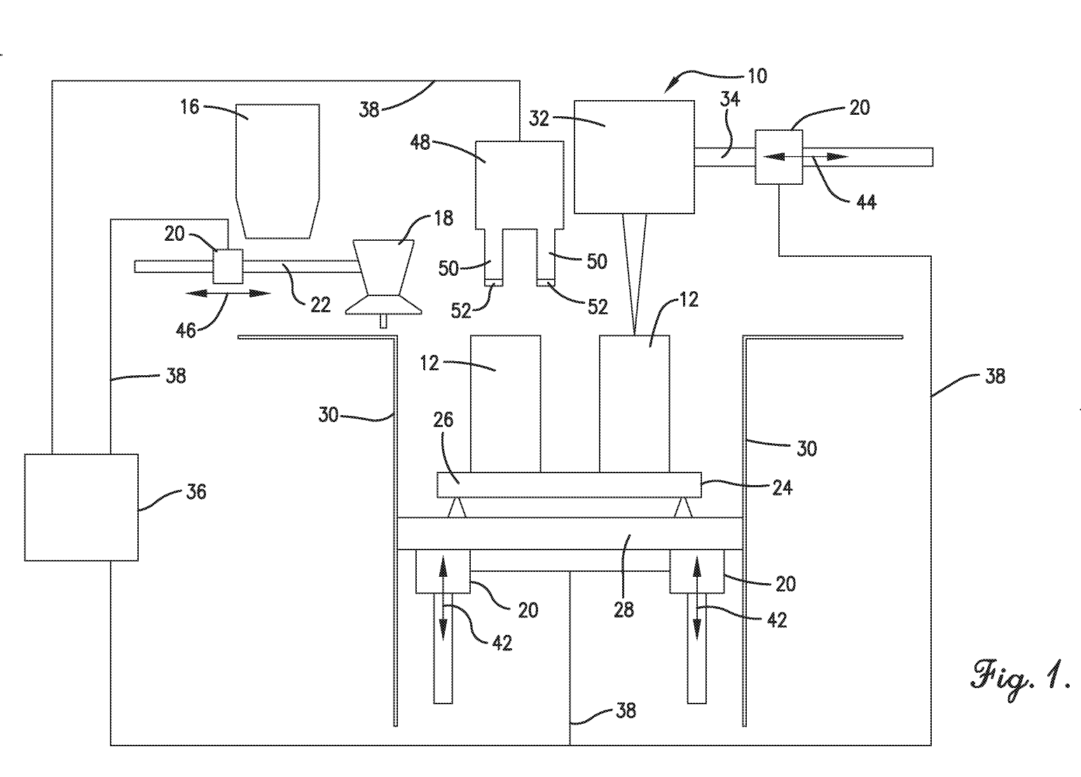

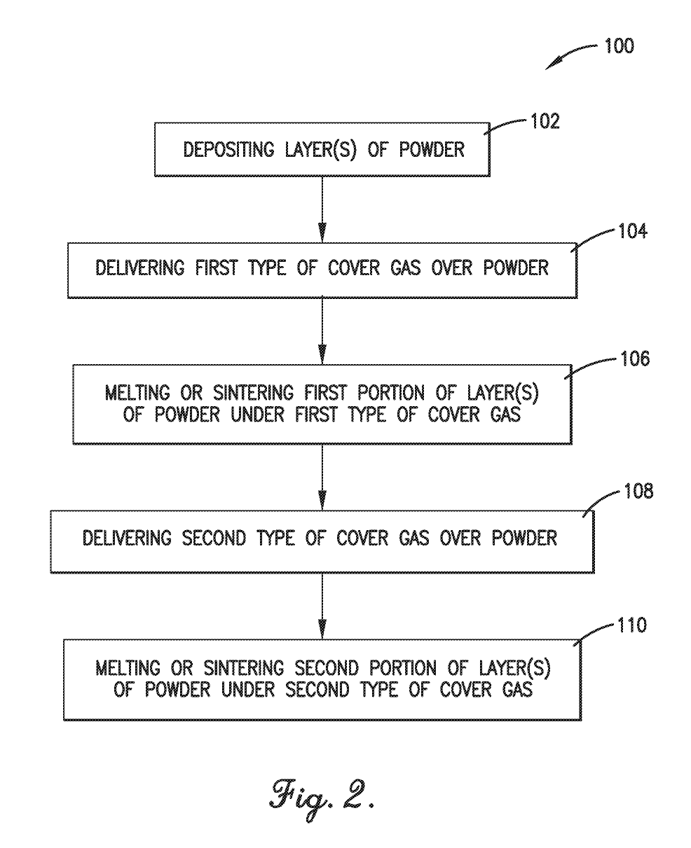

Embodiments of the invention, illustrated in FIGS. 1-2, include an additive manufacturing apparatus 10 and a method 100 of additive manufacturing using an additive manufacturing powder 12 and various cover gases 14,16. As illustrated in FIG. 1, the additive manufacturing apparatus 12 may comprise at least one powder hopper 16, a plurality of actuators 20, a powder deposition device 18, a build platform 24, a directed energy source 32, a gas regulator 48, and a controller 36, as described in detail below. The additive manufacturing powder 12 may comprise any number of materials including material that has a high melting point or low melting point, or a combination of both. The additive manufacturing powder 12 may include one or more of the following materials: metal, metal alloys, carbon fiber, silicon, plastic, or other material in powder form. In one example embodiment of the invention, the additive manufacturing powder 12 is used to form a precipitation-hardenable metal part.

One or more types of the additive manufacturing powder 12 may be stored in the hopper 16, which may be a single hopper or may include separate compartments of a multi-material powder hopper. In embodiments of the invention where multiple powders are used, the powder hopper 16 may house the different types of powder in separate containers or compartments, or may use walls to keep the powders separate. The powder hopper 16 may also comprise a nozzle, or plurality of nozzles, through which powder is selectively supplied. The nozzle or plurality of nozzles can supply powder using solenoids, actuators, or a combination thereof. In one preferred embodiment, the nozzle, or plurality of nozzles, supply powder to a powder deposition device 18 positioned below the nozzle, or plurality of nozzles.

The actuators 20 may be controlled hydraulically, electrically, or manually. For example, the actuators 20 may comprise electric motors, pumps, circuits, robotic parts, mechanical actuation parts, hydro-mechanical parts, electro-mechanical parts, and the like. In some embodiments of the invention, the actuators 20 may comprise a first actuator configured to actuate travel of a portion of the build platform 24, a second actuator configured to actuate travel of the directed energy source 32 relative to the build platform 24, and a third actuator configured to actuate travel of at least a portion of the powder deposition device 18 relative to the build platform 24, as illustrated in FIG. 2. In some embodiments of the invention, the first actuator may be configured to actuate travel in directions 42 substantially perpendicular to directions 44,46 of travel provided by the second and third actuators, respectively. Furthermore, in some embodiments of the invention, the actuators may be configured to provide travel in two or more directions. Note that the actuators described herein are merely exemplary and do not limit the scope of the invention. For example, the build platform could remain stationary while only the directed energy source 32 and the deposition device 18 are actuated. Alternatively, the directed energy source 32 may remain stationary while the build platform is actuated toward and/or away from the directed energy source 32.

In some preferred embodiments of the invention, the deposition device 18 contains multiple selectively openable compartments in which it stores powder supplied by the powder hopper 16. In another preferred embodiment, the deposition device 18 contains only one powder compartment that stores the type of powder to be immediately deposited. In yet another preferred embodiment, the deposition device 18 is coupled to the hopper 16 so that it deposits the type of powder selectively supplied by the hopper 16. Furthermore, the powder deposition device 18 may comprise a nozzle, or plurality of nozzles, which may be turned on or off according to commands received by the controller 36, thereby applying a desired amount and pattern of powder on the build platform 24. As noted above, the nozzle or plurality of nozzles can supply powder using solenoids, actuators, or a combination thereof.

The powder deposition device 18 may comprise at least one of the actuators 20 (such as the third actuator) and/or a track 22 upon which the deposition device 18 may move to selectively deposit the powder. The actuators 20 may actuate the movement of the deposition device 18 on the track 22, moving the position of the deposition device 18 over any region above a build platform 24. As illustrated in FIG. 4, in one embodiment the deposition device 18 may be a multi-material dispensing rake 18.

The build platform 24 broadly comprises a horizontal build plate 26 or base plate and at least one vertical wall surrounding the build plate 26. In one preferred embodiment the build plate 26 sits on top of a rectangular, horizontal elevator plate 28, where four vertical walls 30 enclose the elevator plate 28, as illustrated in FIG. 1. The elevator plate 28 is vertically movable using actuators 20 (such as the first actuator above), where the elevator plate 28 is vertically movable relative to the four vertical walls 30.

The directed energy source 32 may be any kind as is known in the art including but not limited to a laser, electron beam, or other source of directed energy. The energy source 32 may be movably attached to a track 34 such that the energy source 32 can move anywhere in the three-dimensional space above the build platform 24. In one embodiment, the energy source 32 may be movable within a two-dimensional plane parallel to and above the build platform 24. The energy source 32 may also be movable such that it can direct its energy in any direction or angle relative to the plane parallel to the build platform 24. The movement, position, and direction of the energy source 32 may be manually controlled or caused by one or more of the actuators 20 of the types described above (such as the second actuator above). The actuators 20 of the directed energy source 32 may be controlled by the controller 36.

The gas regulator 48 may include and/or be connected to one or more gas sources and may also include a plurality of ports 50 and valves 52, controlling delivery of cover gases flowing over and/or substantially surrounding one or more layers of the additive manufacturing powder on the build platform 24. The gas regulator 48 may be controlled manually via a user interface including switches, knobs, or other various controls known in the art for opening or closing the valves 52 and/or otherwise controlling the flow of the cover gases through the ports 50. Additionally or alternatively, a controller of the gas regulator 48, such as the controller 36, may be configured for controlling recirculation, venting, and/or flow rate of the cover gases. Thus, the gas regulator 48 may also include various hardware, ports, and/or conduits configured for facilitating recirculation, venting, and/or flow rate of gas, as is known in the art. For example, this hardware may include a gas pump, circulating fan, and/or any other hardware known in the art for causing a flow of gas into and/or out of a desired area. The cover gases may include any inert gases, such as nitrogen, argon, and the like, or any combination thereof.

The controller 36 may comprise any number of combination of controllers, circuits, integrated circuits, programmable logic devices such as programmable logic controllers (PLC) or motion programmable logic controllers (HPLC), computers, processors, microcontrollers, transmitters, receivers, other electrical and computing devices, and/or residential or external memory for storing data and other information accessed and/or generated by the apparatus 10. The controller 36 may control operational sequences, power, speed, motion, or movement of the actuators 20 and/or temperature of the directed energy source 32.

Furthermore, the controller 36 may also control or command the gas regulator 48, and may specifically control gas circulation, venting, and/or flow rate of the cover gas used during melting or sintering of various portions or layers of the additive manufacturing powder 12, as later described herein. In some embodiments of the invention, the apparatus 10 may include a plurality of separate controllers for independently controlling various functions described herein. For example, in some embodiments of the invention, the gas regulator 48 may be an external gas regulator with its own independent controller, separate from a controller for the actuators 20 and/or the directed energy source 32.

The controller 36 may be configured to implement any combination of algorithms, subroutines, computer programs, or code corresponding to method steps and functions described herein. The controller 36 and computer programs described herein are merely examples of computer equipment and programs that may be used to implement the present invention and may be replaced with or supplemented with other controllers and computer programs without departing from the scope of the present invention. While certain features are described as residing in the controller 36, the invention is not so limited, and those features may be implemented elsewhere. For example, databases may be accessed by the controller 36 for retrieving CAD data or other operational data without departing from the scope of the invention.

The controller 36 may implement the computer programs and/or code segments to perform various method steps described herein. The computer programs may comprise an ordered listing of executable instructions for implementing logical functions in the controller 36. The computer programs can be embodied in any computer-readable medium for use by or in connection with an instruction execution system, apparatus, or device, and execute the instructions. In the context of this application, a “computer-readable medium” can be any physical medium that can contain, store, communicate, propagate, or transport the program for use by or in connection with the instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), a portable compact disk read-only memory (CDROM), an optical fiber, multi-media card (MMC), reduced-size multi-media card (RS MMC), secure digital (SD) cards such as microSD or miniSD, and a subscriber identity module (SIM) card.

The residential or external memory may be integral with the controller 36, stand-alone memory, or a combination of both. The memory may include, for example, removable and non-removable memory elements such as RAM, ROM, flash, magnetic, optical, USB memory devices, MMC cards, RS MMC cards, SD cards such as microSD or miniSD, SIM cards, and/or other memory elements. As illustrated in FIG. 1, electrical conduits 38 and/or communication conduits 38 may also provide electrical power to the actuators 20, the powder hopper 16, the deposition device 18, the nozzles or nozzle solenoids, the build platform 24, the directed energy source 32, and/or the gas regulator 48. Additionally or alternatively, the conduits 38 may be configured to provide communication links between the controller 36 and any of the actuators 20, the powder hopper 16, the deposition device 18, the nozzles or nozzle solenoids, the build platform 24, the directed energy source 32, and/or the gas regulator 48.

In use, the additive manufacturing apparatus 10 may selectively deposit the additive manufacturing powder 12 using the deposition device 18 and selectively melt or sinter the powder 12 using the directed energy source 32 to form a part 40, layer by layer. Specifically, the depositing and melting or sintering steps may be repeated one or more times, until the part 40 is complete. At various points during this process, the air regulator 48 may provide various cover gases or mixtures thereof to cover the powder 12 deposited on the build platform 24. For example, the cover gas may be changed for melting or sintering different portions of a single layer and/or changed between depositions of one or more layers, depending on desired structural properties or desired microstructure of the part 40 at various locations and/or for various layers thereof.

Advantageously, additive manufacturing using in situ cover gas change, as described herein, may allow for manipulation of mechanical properties and microstructures of specific areas, layers, or portions of the resulting part 40 without modifying laser speed, laser power, or starting chemistry of the powder 12. In some applications, the methods described herein may be used to create a gradient microstructure throughout the part 40 and/or unique characteristics such as higher strength or ductility in certain areas of the part 40.

The flow chart of FIG. 2 depicts the steps of an exemplary method 100 for additive manufacturing the part 40 including changing the type of cover gas provided to the additive manufacturing powder 12 at one or more points during manufacturing of the part 10. In some alternative implementations, the functions noted in the various blocks may occur out of the order depicted in FIG. 2. For example, two blocks shown in succession in FIG. 2 may in fact be executed substantially concurrently, or the blocks may sometimes be executed in the reverse order depending upon the functionality involved. Some or all of the steps described below and illustrated in FIG. 2 may also represent executable code segments stored on the computer-readable medium described above and/or executable by the controller 36.

The method 100 may comprise the steps of depositing at least one layer of the additive manufacturing powder 12 onto the build platform 24, as depicted in block 102, then delivering a first type of cover gas to the build platform 24, as depicted in block 104. This may be accomplished via the deposition device 18, as described above. The specific location and pattern of placement of the powder 12 on the build platform 24 may be according to computer-aided design (CAD) data, or other technical model or drawing, as followed manually by a user or as directed in an automated or semi-automated fashion via control signals provided from the controller 36 to the deposition device 18 and its associated actuators 20 (such as the third actuator). The first type of cover gas may be a single type of inert cover gas or any mixture of different types of inert cover gases. The first type of cover gas may be provided via actuation of one of the valves 52, either manually or in an automated or semi-automated fashion via control signals from the gas regulator 48 and/or the controller 36.

Next, the method 100 may include a step of melting or sintering a first portion of the at least one layer of the additive manufacturing powder 12 on the build platform 24, as depicted in block 106. This melting or sintering of step 106 may occur under cover of the first type of cover gas. This may include tracing over the powder 12 with the directed energy source 32, fusing the first layer of the part 40. Specifically, after the first layer of powder has been deposited on the build platform 24, the directed energy source 32 may be selectively actuated to travel over the build powder regions and/or may be selectively turned on and off, thus melting or sintering the powder 12 only in desired regions for forming the desired part 40. For example, a laser beam emitted from the directed energy source 32 may be directed to trace or travel over/through the powder 12 and its corresponding regions on the build platform 24. The tracing of the energy source 32 can be done according to CAD data, models, drawings, or other technical resources. The tracing of the energy source 32 over the powder 12 causes the powder 12 to fuse together, forming one layer of the part 40 in solid form.

The method 100 may then include delivering a second type of cover gas to the build platform 24, as depicted in step 108, in addition to or in place of the first type of cover gas. For example, this may or may not include venting the first type of cover gas prior to delivering the second type of cover gas. The second type of cover gas may be a single type of inert cover gas or any mixture of different types of inert cover gases. Furthermore, the second type of cover gas may be different than the first type of cover gas. For example, different inert cover gases may be used and/or there may be a change in the mixture percentages for various inert cover gases. If the second type of cover gas is provided in place of the first type of cover gas, various venting ports and/or other hardware parts of the gas regulator may be used to substantially eliminate the first type of cover gas from an area around the build platform 24 and/or the deposited powder 12 prior to pumping the second type of cover gas toward the build platform 24 and/or the deposited powder 12.

Note that any of steps 102-106 may be repeated multiple times before step 108 or may not be repeated at all prior to step 108 being performed. Specifically, once one layer of the part 40 has been fused, a next layer of powder can be deposited. This is may be accomplished through first lowering the build platform 24 relative to the energy source 32 or deposition device 18. The lowering may also comprise lowering the base or build plate 26 relative to the walls 30. Once the lowering has occurred, the process may repeat in that the next layer of powder may be deposited onto a previous layer of the part 40. During steps 106, the powder 12 fuses together and also fuses to adjacent previous layers of the part 40.

However, following step 108, the method 100 may include a step of melting or sintering a second portion of the at least one layer of the additive manufacturing powder, as depicted in step 110, while the second portion is exposed to the second type of cover gas. So, for example, the first portion from step 106 may be a first layer of the additive manufacturing powder and the second portion of step 110 may be a second layer of the additive manufacturing powder. Additionally or alternatively, the first portion from step 106 and the second portion from step 110 may both be different portions of a first layer of the additive manufacturing powder. That is, a layer of the powder 12 may be deposited, first portions of the layer may be melted under the first cover gas, and then the second cover gas could be applied while second portions of the layer are selectively melted by the directed energy source 32. Note that the second type of cover gas may be different in mixture and/or composition than the first type of cover gas.

Although the invention has been described with reference to the one or more embodiments illustrated in the figures, it is understood that equivalents may be employed and substitutions made herein without departing from the scope of the invention as recited in the claims. For example, the use of two different types of cover gases (or mixtures thereof) are described herein, however any number or combination of different cover gases may be used during additive manufacturing of the part 40 without departing from the scope of the invention. For example, three or four different types of cover gas could be used at different points during additive manufacturing of different layers of the powder 12 and/or during melting or sintering of three or four different portions of one or more layers of the powder 12. Furthermore, changing of cover gases during additive manufacturing as described herein could be used with other types of additive manufacturing apparatuses and techniques, such as any type of selective laser melting, selective laser sintering, or blown powder deposition without departing from the scope of the invention.

Having thus described one or more embodiments of the invention, what is claimed as new and desired to be protected by Letters Patent includes the following:

1. A method of additive manufacturing comprising:
(a) depositing an additive manufacturing powder onto a surface;
(b) delivering a first type of cover gas over the additive manufacturing powder;
(c) melting or sintering a first portion of the additive manufacturing powder while the first portion is exposed to the first type of cover gas;
(d) delivering a second type of cover gas to the surface, covering the additive manufacturing powder; and
(f) melting or sintering a second portion of the additive manufacturing powder while the second portion is covered by the second type of cover gas.

2. The method of claim 1, wherein the first portion is a first layer of the additive manufacturing powder and the second portion is a second layer of the additive manufacturing powder, deposited after the step of melting or sintering the first portion.

3. The method of claim 1, wherein the first portion and the second portion are both different portions of a first layer of the additive manufacturing powder.

4. The method of claim 1, wherein the melting or sintering steps are performed by a directed energy source or laser.

5. The method of claim 1, wherein the additive manufacturing powder is comprised of precipitation-hardenable metal in powder form.

6. The method of claim 1, wherein the types of cover gas are delivered via a gas regulator having multiple ports and valves selectively controlling delivery of the cover gases over the additive manufacturing powder on the surface.

7. The method of claim 6, further comprising controlling at least one of recirculation, venting, and flow rate of the cover gases via the gas regulator or a controller communicably coupled to parts of the gas regulator.

8. The method of claim 1, wherein the first cover gas and the second cover gas are inert cover gases of differing types or of differing mixture ratios.

9. The method of claim 1, further comprising a step of venting the first type of cover gas prior to delivering the second type of cover gas.

10. A method of additive manufacturing comprising:
(a) depositing a first layer of additive manufacturing powder onto a build platform of an additive manufacturing apparatus;
(b) delivering a first type of cover gas over the first layer of additive manufacturing powder;
(c) melting or sintering the first layer of additive manufacturing powder on the build platform using a directed energy source while the first type of cover gas covers the first layer of additive manufacturing powder;
(d) depositing a second layer of the additive manufacturing powder onto the first layer of additive manufacturing powder deposited onto the build platform;
(e) delivering a second type of cover gas over the second layer of additive manufacturing powder; and
(f) melting or sintering the second layer of additive manufacturing powder while the second type of cover gas covers the second layer of additive manufacturing powder.

11. The method of claim 10, wherein the additive manufacturing powder is comprised of precipitation-hardenable metal in powder form.

12. The method of claim 10, wherein the types of cover gases are delivered via a gas regulator having multiple ports and valves controlling delivery of the cover gases over the additive manufacturing powder on the build platform.

13. The method of claim 12, further comprising controlling at least one of recirculation, venting, and flow rate of the cover gases via the gas regulator or a control system associated with the gas regulator.

14. The method of claim 10, wherein the cover gases may include at least one of nitrogen or argon.

15. An additive manufacturing apparatus for using multiple types of cover gas during additive manufacturing of a metal part, the apparatus comprising:
a build platform;
a powder deposition device configured for depositing an additive manufacturing powder onto the build platform;
a directed energy source configured for melting or sintering the additive manufacturing powder on the build platform;
a gas regulator configured for outputting at least two different types of cover gas over the additive manufacturing powder on the build platform; and
a controller communicably coupled to the build platform, the directed energy source, the powder deposition device, and the gas regulator, wherein the controller is configured to perform the following steps:
(a) commanding the powder deposition device to deposit the additive manufacturing powder onto the build platform;
(b) commanding the gas regulator to deliver a first type of cover gas to the build platform, covering the additive manufacturing powder;
(c) commanding the directed energy source to melt or sinter a first portion of the additive manufacturing powder on the build platform while the first portion is exposed to the first type of cover gas;
(d) commanding the gas regulator to deliver a second type of cover gas to the build platform, covering the additive manufacturing powder; and
(f) commanding the directed energy source to melt or sinter a second portion of the additive manufacturing powder while the second portion is exposed to the second type of cover gas.

16. The apparatus of claim 15, wherein the first portion is a first layer of the additive manufacturing powder and the second portion is a second layer of the additive manufacturing powder, deposited after melting or sintering of the first portion.

17. The apparatus of claim 15, wherein the first portion and the second portion are both different portions of a first layer of the additive manufacturing powder.

18. The apparatus of claim 15, wherein the gas regulator comprises multiple ports and valves communicably coupled with the controller for selectively controlling delivery of the cover gases over the additive manufacturing powder on the build platform.

19. The apparatus of claim 18, wherein the controller is further configured for controlling at least one of recirculation, venting, and flow rate of the cover gases via the gas regulator.

20. The apparatus of claim 15, further comprising actuators associated with at least one of the powder deposition device and the directed energy source, wherein the controller is communicably coupled to the actuators.
